(19) United States
(12) Patent Application Publication
(10) Pub. No.: US 2026/0213695 A1
(43) Pub. Date: Jul. 23, 2026

(54) Deploying Solar Systems

(71) Applicant: Saudi Arabian Oil Company, Dhahran (SA)

(72) Inventors: Ahmad D. Hammad, Dhahran (SA); Issam Thaher Amr, Al Khobar (SA); Yasmeen Aldawsari, Dhahran (SA)

(21) Appl. No.: 19/036,247

(22) Filed: Jan. 24, 2025

(30) Foreign Application Priority Data
Jan. 22, 2025 (GR) 20250100047

(51) Int. Cl. H02S 10/40; H02S 20/30; H02S 30/20; H02S 40/10; H02S 40/38

(52) U.S. Cl. CPC H02S 10/40; H02S 20/30; H02S 30/20; H02S 40/10; H02S 40/38

(57) ABSTRACT

An approach based on a containerized system can be used to provide electricity to an electrical load at a site not connected to an electrical grid. The system can include a portable container. One or more solar panels can be coupled to the portable container and movable between a stored position in the portable container and a deployed position extending from the portable container. A cleaning arm can be attached to the portable container and positioned to contact the first face of the one or more solar panels during movement of the one or more solar panels between the stored position and the deployed position.

### CROSS-REFERENCE TO RELATED PATENT APPLICATION

This application claims benefit of priority to Greek Patent Application No. 20250100047, filed Jan. 22, 2025, the contents of which are incorporated by reference herein.

### TECHNICAL FIELD

This specification generally relates to solar energy, particularly to deployment and cleaning of solar panels.

### BACKGROUND

Solar energy is radiant energy from the sun's light and heat. Solar energy can be harnessed using solar panels which convert sunlight into electricity using photovoltaic cells. Photovoltaic cells are made of materials that produce excited electrons when exposed to light. The electrons flow through a circuit and produce direct current electricity, which can be used to power various devices or be stored in batteries.

Solar panels are usually arranged in groups with each group including one or more solar panels, an inverter that converts DC electricity to alternating current (AC) electricity, and sometimes other components such as controllers, meters, and trackers.

### SUMMARY

This specification describes an approach to deploying mobile solar systems. This approach is based on methods and systems for cleaning and storing solar panels in which the solar panels are cleaned as they are retracted into a container. The container has a cleaning arm with, for example, a nylon or polyester brush. The cleaning arm can have an adjustable height. In some cases, the systems also include a dust container below the cleaning arm to collect dust or particles removed from the solar panels. In this approach, the solar panels are cleaned by the brushes as they are stored in the container, preventing further accumulation of dust when the solar panels are not in use.

The approach described in this specification can provide one or more of the following advantages. This approach can provide a mobile solar system temporarily deployable to remote sites such as gas and oil wells, remote data centers, and telecommunication towers. The container provides storage for the solar panels during transport and during periods of inactivity (e.g., at night).

These systems can be useful in dessert environments where ample sunlight is available for conversion to electricity but windborne particles (e.g., dust and sand) can land on and coat active surfaces of the solar panels. By cleaning the active surfaces of solar panels, these systems limit the impact of dust and sand on the effectiveness of the solar panels. This approach can reduce operational costs by reducing the need for maintenance and avoiding the need to contract surface cleaning companies.

The details of one or more embodiments of these systems and methods are set forth in the accompanying drawings and the description below. Other features, objects, and advantages of these systems and methods will be apparent from the description and drawings, and from the claims.

### DESCRIPTION OF DRAWINGS

FIGS. 1A-1D illustrate deployment of a containerized solar module at a remote site.

FIGS. 2A and 2B are schematic illustrations of components of the containerized solar system of FIGS. 1A-1D.

FIG. 3 is a flow chart of a method of providing electricity at a remote site using a containerized solar system.

FIG. 4 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

This specification describes an approach to deploying mobile solar systems. This approach is based on methods and systems for cleaning and storing solar panels in which the solar panels are cleaned as they are retracted into a container. The container has a cleaning arm with, for example, a nylon or polyester brush. The cleaning arm can have an adjustable height. In some cases, the systems also include a dust container below the cleaning arm to collect dust or particles removed from the solar panels. In this approach, the solar panels are cleaned by the brushes as they are stored in the container, preventing further accumulation of dust when the solar panels are not in use.

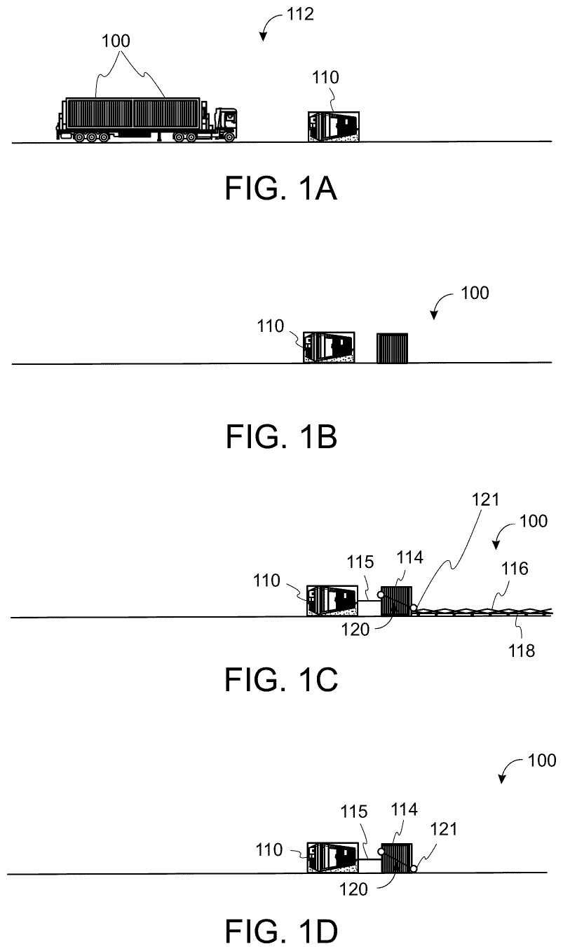

FIGS. 1A-1D illustrate deployment of a containerized solar system 100 at a remote site. In FIG. 1A, two solar systems 100 are being transported to an off-grid field office 110 on a tractor-trailer 112. After arrival, one of the solar systems 100 is off-loaded near the equipment or facility (in this case the field office 110) to which the solar system 100 will be supplying electricity as shown in FIG. 1B.

The solar system 100 includes a container 114 storing an array of solar panels 116 mounted on support rails 118. The size of the container 114 is proportional to the size and number of the solar panels 116. The solar system 100 is connected to the field office 110 using a power cable 115 as shown in FIG. 1C. During the day, an array of solar panels 116 mounted on support rails 118 are deployed from the container 114. A cleaning arm 120 is pivotably attached to the container 114 with brushes 121 of the cleaning arm 120 is positioned to contact an upper face of the solar panels 116 during movement between their stored position and their deployed position. During transport, the cleaning arm will be positioned at the top of the container and kept into that position by locking the pivot from moving. The arm is then released by the weight of its brush and oriented to its final position on top of the solar panels by choosing the wanted pivot angle and arm height.

The solar system is typically positioned with the array of solar panels extending southward from the container to orient the solar panels 116 for good exposure to sunlight. At night or when cleaning is needed (e.g., when panels are visibly dirty, when voltages generated by the solar panels decrease, etc.), the solar panels are moved to their retracted position in the container 114 as shown in FIG. 1D. As the solar panels are moved into their retracted position, their upper surface is wiped by the cleaning arm.

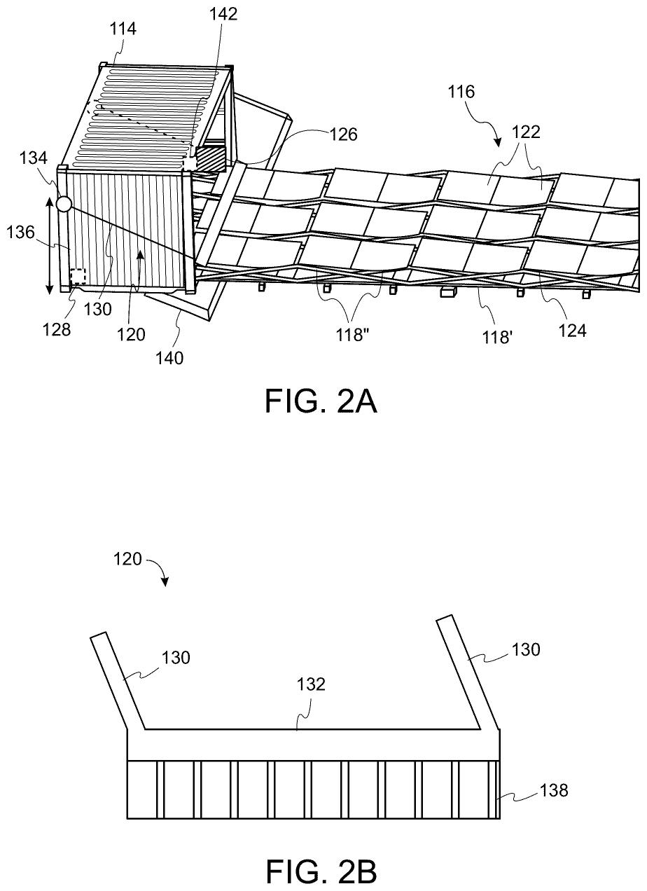

FIG. 2A is more detailed view of the solar system 100 with the array of solar panels 116 extended from the container 114 in their deployed position. The more detailed view also shows a motor 126 and a control system 128 mounted in the container 114. FIG. 2B is a schematic illustration of the cleaning arm 120.

Each solar panel 116 includes photovoltaic cells 122 mounted on a rigid backing 124. The rigid backing 124 supports the photovoltaic cells 122 and maintains the generally rectangular shape of the solar panel 116. The photovoltaic cells 122 have an active face configured to receive sunlight oriented to a first or upper face of the solar panel 116. The solar panels 116 are illustrated as each having two photovoltaic cells 122 but can have more or fewer photovoltaic cells.

As can be seen most clearly in FIG. 2B, the cleaning arm 120 has two side bars 130 and a foot 132 attached to each other in a U-shape. The side bars 130 are pivotably attached to the container 114 at pivots 134. The pivots are mounted in tracks 136 on ends of the container 114 on a side of the container 114 opposite the opening through which the solar panels 116 are extended from or retrieved into in the container 114. The open side of the container has a rolling door (garage door opening system/mechanism). The door engages an automatic lock or brake when fully opened to prevent accidental movement. The height of the pivots 134 relative to the bottom of the container is adjustable along the tracks 136. The foot 132 of the cleaning arm 120 is positioned across the opening through which the solar panels 116 are extended from or retrieved into in the container 114. The cleaning arm 120 is positioned to contact the first face of the solar panels 116 during movement between the stored position and the deployed position of the solar panels 116. A set of brushes 138 are mounted on the foot 132 of the cleaning arm 120. To reduce the possibility that the bushes 138 damage the solar panels while cleaning them, brushes with soft bristles (e.g., flexible nylon or polyester bristles) are preferred.

Some systems use other approaches to mounting the brushes. For example, the bushes can be mounted on or incorporated in the bottom of the rolling door. If this system is used, the door will be lowered and locked into a level where the brushes come in contact with the solar panels.

A dust collector 140 is positioned at the entrance to the container under the brushes 138 of the cleaning arm. The dust collector has a curved surface and made of materials like metal, plastic, or coated surfaces that are durable and easy to clean. During cleaning, the dust settles on the plate naturally due to gravity, especially in still air conditions. Dust is periodically removed from the plate by removing the dust collector itself to a waste bin. If the panels are in a desert, the dust can simply be dropped onto the ground by flipping the collector. The dust collector can also be electrostatically charged to attract dust particles more effectively during cleaning. During movement of the solar panels 166 in and out of the container 114, the horizontally placed soft bristles brush dust and particles from the upper sides of the solar panels 116 into the dust collector 140.

As can be seen most clearly in FIG. 2A, the support rails 118 are attached to and extendable from the portable container 114 with the solar panels 116 mounted on the support rails 118. The support rails 118 include both base rails 118′ and side rails 118″. The base rails 118′ are to extend from the portable container along a ground surface on which the portable container is positioned. The side rails 118″ are attached to the base rails 118′ at an adjustable angle. The side rails 118″ are also attached to the solar panels 116 and couple the base rails 118′ to the solar panels 116.

The motor 126 is operable to move the support rails 118 and the solar panels 116 between stored and deployed positions. The support rails act as a guiding system to ensure the solar panels deploy evenly and remain aligned. Panels may include sliding bearings, wheels, or rollers that run along the support rails to reduce friction and enable smooth motion. The motor shaft is directly connected to the solar panel roller. As the motor rotates, it unrolls or rolls the panels along the support rails. In the system 100, the motor is an electric motor powered by one or more batteries 142. The batteries can be charged by electricity generated by the solar panels 116. Some systems use other motors (e.g., gasoline-powered motors) or, for small systems, manual deployment systems.

The control system 128 is mounted in the container 114 and is in communication with the motor 126. The control system 142 is operable to send signals to operate the motor 126 to move the support rails 118 and the solar panels 116 between the stored position and the deployed position. For example, the control system 128 can be operable to receive signals associated with voltages produced by the solar panels and, in response to a drop in the voltages produced by the solar panels 116, to send the signals to operate the motor 126 to move the support rails 118 and the solar panels 116 between the stored position and the deployed position. In this approach, a drop in the voltages produced during periods of high sunlight is used as an indicator that dust and other particles have collected on the solar panels 116. The control system 128 can also be operable to deploy or retract the support rails 118 and the solar panels 116 based on other triggers (e.g., at nightfall, an operator's command, or decreased electrical load).

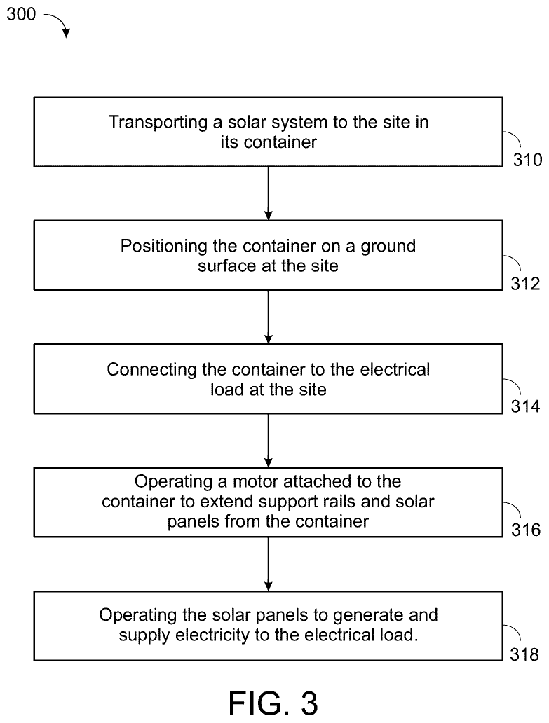

FIG. 3 is a flow chart of a method 300 of providing electricity to an electrical load at a site not connected to an electrical grid. The method 300 is described with reference to the solar system 100 discussed with reference to FIGS. 1A-2B. Although the associated reference numbers are used in the following description for ease of description, the method 300 can be performed with other solar systems.

A solar system 100 is transported to the site in its container (step 310). In FIGS. 1A-1D, the container 114 of the solar system 100 are sized to fit two solar systems 100 on a single tractor-trailer 112. Smaller systems can be transported, for example, on a flatbed truck or a pickup truck.

After arrival, the container is positioned on a ground surface at the site (step 312). The solar system 100 is large enough to require mechanical assistance (e.g., a crane or forklift) to offload it from the tractor-trailer 112. Some systems are small enough that they can be offloaded manually by a field crew. The container 114 is preferably positioned on a generally flat surface (e.g., a concrete pad or compacted earth). In the northern hemisphere, the container 114 is preferably oriented so the solar panels 116 and support rails 118 will extend from the container in a generally southward direction when deployed.

The container 114 is connected to the electrical load at the site (step 314). Typically, a power cable 115 extending from the back or side of the container is used to connect the solar system 100 to the load (e.g., remote office 110). The power cable 115 can be an integral component of the solar system (e.g., mounted on reel positioned in a recess defined in the back or side of the container). Some systems include a flush-mounted outlet connection and the power cable is supplied separately rather than being an integral part of the system.

A cleaning arm 120 is pivotably attached to the container 114 with brushes 121. The brushes 121 are positioned to contact an upper face of the solar panels 116 during movement between their stored position and their deployed position. The brushes 121 comprises nylon or polyester and once they come in contact with the panels, they brush off the dust into the dust collector.

After setup, a motor 126 attached to the container 114 is operated to extend support rails 118 and solar panels 116 from the container (step 316). As previously discussed, deployment triggers can include sunrise or operator commands. During movement of the solar panels 166 out of the container 114, the horizontally placed soft bristles brush dust and particles from the upper sides of the solar panels 116 into the dust collector 140.

Once deployed, the solar panels 116 operate to generate and supply electricity to the electrical load (step 318). The generated electricity may be supplied directly to the load or may be stored in batteries.

The motor 126 can be operated by the control system 128 to retract the solar panels 116 and support rails 118. As previously discussed, retraction triggers can include nightfall, an operator's command, or decreased electrical load.

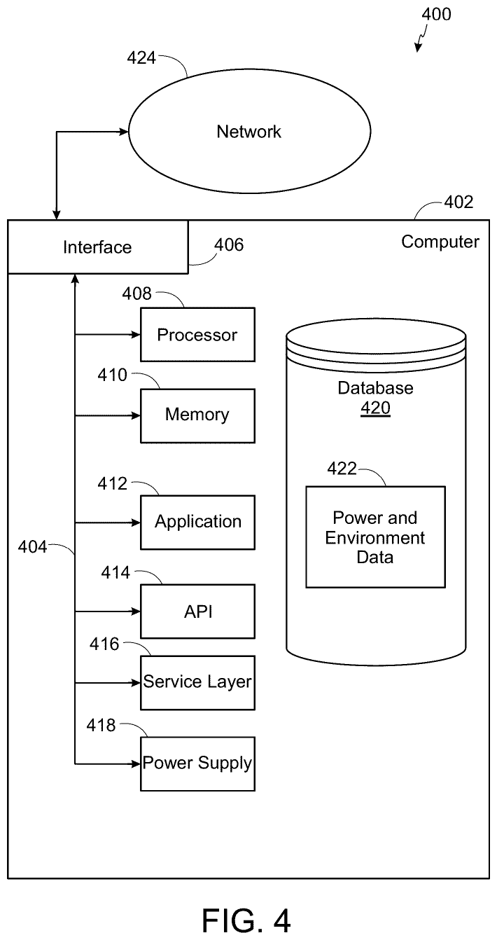

FIG. 4 is a block diagram of an example data processing system 400 used to provide computational functionalities associated with described algorithms, methods, functions, processes, flows, and procedures described in the present disclosure. For example, the data processing system 400 can be configured to control the solar system 100. The data processing device 402 can include input devices such as keypads, keyboards, and touch screens that can accept user information. Also, the data processing device 402 can include output devices that can convey information associated with the operation of the data processing device 402. The information can include digital data, visual data, audio information, or a combination of information. The information can be presented in a graphical user interface (UI) (or GUI).

The data processing device 402 can serve in a role as a client, a network component, a server, a database, a persistency, or components of a computer system for performing the subject matter described in the present disclosure. The illustrated data processing device 402 is communicably coupled with a network 424. In some implementations, one or more components of the data processing device 402 can be configured to operate within different environments, including cloud-computing-based environments, local environments, global environments, and combinations of environments.

The data processing device 402 can receive requests over network 424 from a client application (for example, executing on another data processing device 402). The data processing device 402 can respond to the received requests by processing the received requests using software applications. Requests can also be sent to the data processing device 402 from internal users (for example, from a command console), external (or third) parties, automated applications, entities, individuals, systems, and computers.

Each of the components of the data processing device 402 can communicate using a system bus 404. In some implementations, any or all of the components of the data processing device 402, including hardware or software components, can interface with each other or the interface 406 (or a combination of both), over the system bus 404. Interfaces can use an application programming interface (API) 414, a service layer 416, or a combination of the API 414 and service layer 416. The API 414 can include specifications for routines, data structures, and object classes. The API 414 can be either computer-language independent or dependent. The API 414 can refer to a complete interface, a single function, or a set of APIs.

The service layer 416 can provide software services to the data processing device 402 and other components (whether illustrated or not) that are communicably coupled to the data processing device 402. The functionality of the data processing device 402 can be accessible for all service consumers using this service layer. Software services, such as those provided by the service layer 416, can provide reusable, defined functionalities through a defined interface. For example, the interface can be software written in JAVA, C++, or a language providing data in extensible markup language (XML) format. While illustrated as an integrated component of the data processing device 402, in alternative implementations, the API 414 or the service layer 416 can be stand-alone components in relation to other components of the data processing device 402 and other components communicably coupled to the data processing device 402. Moreover, any or all parts of the API 414 or the service layer 416 can be implemented as child or sub-modules of another software module, enterprise application, or hardware module without departing from the scope of the present disclosure.

The data processing device 402 includes an interface 406. Although illustrated as a single interface 406 in FIG. 4, two or more interfaces 406 can be used according to implementations of the data processing device 402 and the described functionality. The interface 406 can be used by the data processing device 402 for communicating with other systems that are connected to the network 424 (whether illustrated or not) in a distributed environment. Generally, the interface 406 can include, or be implemented using, logic encoded in software or hardware (or a combination of software and hardware) operable to communicate with the network 424. More specifically, the interface 406 can include software supporting one or more communication protocols associated with communications. As such, the network 424 or the interface's hardware can be operable to communicate physical signals within and outside of the illustrated data processing device 402.

The data processing device 402 includes a processor 408. Although illustrated as a single processor 408 in FIG. 4, two or more processors 408 can be used according to implementations of the data processing device 402 and the described functionality. Generally, the processor 408 can execute instructions and can manipulate data to perform the operations of the data processing device 402, including operations using algorithms, methods, functions, processes, flows, and procedures as described in the present disclosure.

The data processing device 402 also includes a database 420 that can hold data (such as power and environmental data 422) for the data processing device 402 and other components connected to the network 424 (whether illustrated or not). For example, database 420 can be in-memory or a database storing data consistent with the present disclosure. In some implementations, database 420 can be a combination of two or more different database types (for example, hybrid in-memory and conventional databases) according to implementations of the data processing device 402 and the described functionality. While database 420 is illustrated as an internal component of the data processing device 402, in alternative implementations, database 420 can be external to the data processing device 402.

The data processing device 402 also includes a memory 410 that can hold data for the data processing device 402 or a combination of components connected to the network 424 (whether illustrated or not). In some implementations, memory 410 can be a combination of two or more different types of memory (for example, a combination of semiconductor and magnetic storage) according to implementations of the data processing device 402 and the described functionality. While memory 410 is illustrated as an internal component of the data processing device 402, in alternative implementations, memory 410 can be external to the data processing device 402.

The application 412 can be an algorithmic software engine providing functionality according to implementations of the data processing device 402 and the described functionality. For example, application 412 can serve as one or more components, modules, or applications.

The data processing device 402 can also include a power supply 418. The power supply 418 can include a rechargeable or non-rechargeable battery that can be configured to be either user- or non-user-replaceable.

There can be any number of computers 402 associated with, or external to, a computer system including the data processing device 402, with each data processing device 402 communicating over network 424. Further, the terms “client,” “user,” and other appropriate terminology can be used interchangeably, as appropriate, without departing from the scope of the present disclosure. Moreover, the present disclosure contemplates that many users can use one data processing device 402 and one user can use multiple computers 402.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based).

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random-access memory (RAM), read only memory (ROM), phase change memory (PRAM), static random-access memory (SRAM), dynamic random-access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

### EXAMPLES

In some implementations, systems for producing electricity include a portable container; one or more solar panels coupled to the portable container and movable between a stored position in the portable container and a deployed position extending from the portable container; and a cleaning arm attached to the portable container and positioned to contact the first face of the one or more solar panels during movement of the one or more solar panels between the stored position and the deployed position. Each of the one or more solar panels can have rigid backing and at least one photovoltaic cell attached to the rigid backing with an active face oriented to a first face of the solar panel.

In an example implementation combinable with any other example implementation, systems also include support rails attached to and extendable from the portable container with the one or more solar panels mounted on the support rails.

In an example implementation combinable with any other example implementation, systems also include a motor operable to move the support rails and the one or more solar panels between the stored position and the deployed position. In some cases, the motor is an electric motor. In some cases, systems also include one or more batteries.

In an example implementation combinable with any other example implementation, systems also include a control system in communication with the motor and configured to send signals to operate the motor to move the support rails and the one or more solar panels between the stored position and the deployed position. In some cases, the control system is configured to receive signals associated with voltages produced by the one or more solar panels and, in response to a drop in the voltages produced by the one or more solar panels, to send the signals to operate the motor to move the support rails and the one or more solar panels between the stored position and the deployed position.

In an example implementation combinable with any other example implementation, the support rails comprise base rails configured, when deployed, to extend from the portable container along a ground surface on which the portable container is positioned. In some cases, the support rails further comprise side rails attached to the base rails at an adjustable angle, the side rails also attached to the one or more solar panels.

In an example implementation combinable with any other example implementation, the cleaning arm comprises a brush extending across a deployed width of the one or more solar panels. In some cases, the brush comprises nylon or polyester.

In an example implementation combinable with any other example implementation, the cleaning arm is pivotably attached to the portable container. In some cases, a height of the cleaning arm relative to a floor of the portable container is adjustable.

In an example implementation combinable with any other example implementation, systems also include a dust collector. In some cases, the dust collector is an electrostatically charged dust collector.

In some implementations, methods of providing electricity to an electrical load at a site not connected to an electrical grid include: transporting a container of a solar system to the site; positioning the container on a ground surface at the site; connecting the container to the electrical load at the site; operating a motor attached to the container to extend support rails and solar panels from the container; and operating the solar panels to generate and supply electricity to the electrical load.

In an example implementation combinable with any other example implementation, methods also include operating the motor attached to the container to retract the support rails and the solar panels into the container.

In an example implementation combinable with any other example implementation, methods also include receiving signals associated with voltages produced by the one or more solar panels and, in response to a drop in the voltages produced by the one or more solar panels, sending signals to operate the motor to move the support rails and the one or more solar panels between the stored position and the deployed position.

In an example implementation combinable with any other example implementation, methods also include positioning brushes attached to the container to contact surfaces of the solar panels while operating the motor attached to the container to retract the support rails and the solar panels into the container. In some cases, positioning brushes comprises adjusting the height of the brushes.

A number of embodiments of the systems and methods have been described. Nevertheless, it will be understood that various modifications may be made without departing from the spirit and scope of this specification. Accordingly, other embodiments are within the scope of the following claims.

1. A solar system for producing electricity, the system comprising:
a portable container;
one or more solar panels coupled to the portable container and movable between a stored position in the portable container and a deployed position extending from the portable container, each of the one or more solar panels with rigid backing and at least one photovoltaic cell attached to the rigid backing with an active face oriented to a first face of the solar panel; and
a cleaning arm assembly attached to the portable container, the cleaning arm assembly comprising:
a pair of pivots mounted on opposing outer surfaces of the portable container;
side bars attached to the pivots; and
a cleaning arm attached to the side bars and positioned to contact the first face of the one or more solar panels during movement of the one or more solar panels between the stored position and the deployed position.

2. The system of claim 1, further comprising support rails attached to and extendable from the portable container with the one or more solar panels mounted on the support rails.

3. The system of claim 2, further comprising a motor operable to move the support rails and the one or more solar panels between the stored position and the deployed position.

4. The system of claim 3, wherein the motor is an electric motor.

5. The system of claim 4, further comprising one or more batteries.

6. The system of claim 3, further comprising a control system in communication with the motor and configured to send signals to operate the motor to move the support rails and the one or more solar panels between the stored position and the deployed position.

7. The system of claim 6, wherein the control system is configured to receive signals associated with voltages produced by the one or more solar panels and, in response to a drop in the voltages produced by the one or more solar panels, to send the signals to operate the motor to move the support rails and the one or more solar panels between the stored position and the deployed position.

8. The system of claim 2, wherein the support rails comprise base rails configured, when deployed, to extend from the portable container along a ground surface on which the portable container is positioned.

9. The system of claim 8, wherein the support rails further comprise side rails attached to the base rails at an adjustable angle, the side rails also attached to the one or more solar panels.

10. The system of claim 1, wherein the cleaning arm comprises a brush extending across a deployed width of the one or more solar panels.

11. The system of claim 10, wherein the brush comprises nylon or polyester.

12. The method of claim 19, wherein positioning the brushes attached to the container to contact surfaces of the solar panels comprises pivoting a cleaning arm on which the brushes are attached relative to the container.

13. The system of claim 1, wherein a height of the cleaning arm relative to a floor of the portable container is adjustable.

14. The system of claim 1, further comprising a dust collector.

15. The system of claim 14, wherein the dust collector is an electrostatically charged dust collector.

16. A method of providing electricity to an electrical load at a site not connected to an electrical grid, the method comprising:
transporting a container of a solar system to the site;
positioning the container on a ground surface at the site;
connecting the container to the electrical load at the site;
operating a motor attached to the container to extend support rails and solar panels from the container, wherein extending the support rails and the solar panels from the container comprises:
extending base rails of the support rails from the container along the ground surface; and
extending side rails along the base rails, the side rails adjustable relative to the base rails at an angle, the side rails attaching the solar panels to the base rails relative to the base rails at the angle; and
operating the solar panels to generate and supply electricity to the electrical load.

17. The method of claim 16, further comprising operating the motor attached to the container to retract the support rails and the solar panels into the container.

18. The method of claim 17, further comprising receiving signals associated with voltages produced by the solar panels and, in response to a drop in the voltages produced by the solar panels, sending signals to operate the motor to move the support rails and the solar panels between a stored position and a deployed position.

19. The method of claim 17, further comprising positioning brushes attached to the container to contact surfaces of the solar panels while operating the motor attached to the container to retract the support rails and the solar panels into the container.

20. The method of claim 19, wherein positioning brushes comprises adjusting a height of the brushes.

21. The system of claim 1, further comprising tracks mounted to outer surface of the portable container, a position of the pivots adjustable along the tracks.

22. The system of claim 1, wherein the side bars and the cleaning arm form a U-shaped structure configured outside the portable container.
